(19) United States
(12) Patent Application Publication
(10) Pub. No.: US 2009/0121834 A1
(43) Pub. Date: May 14, 2009

(54) BIOMETRIC ASSOCIATION MODEL

(76) Inventor: ARI HUOSTILA, Poway, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/939,253

(22) Filed: Nov. 13, 2007

(51) Int. Cl. G06F 7/04

(52) U.S. Cl. 340/5.83

(57) ABSTRACT

According to various embodiments a secure alternative to wired or numeric association models currently required by, for example, Wireless USB, can use biometric data to generate a unique security key that can be used to help secure a connection between a multiple devices. According to one embodiment a fingerprint reader can be used on a wireless USB host and a wireless USB device to generate a unique key that can be used to establish an initial link between them. The host and device can then generate a connection key that can be used for all future communication between the host and the device. Once the connection context has been transferred between the host and the device the fingerprint key can be discarded. According to another embodiment of the invention, a key generated using biometric data can also be used as a connection key, rather than generating an additional key. In this embodiment the biometric key would not be discarded.

### TECHNICAL FIELD

The present invention relates to wireless communication, and more particularly, some embodiments relate to securing wireless links between multiple devices.

### DESCRIPTION OF THE RELATED ART

With the many continued advancements in communications technology, more and more devices are being introduced in both the consumer and commercial sectors with wireless communications capabilities. For example, wireless communication are now commonplace in many home and office environments. Such wireless communication devices allow various devices to share data and other information to enhance productivity or simply to improve their convenience to the user without the need for a wired connection. One such wireless communication standard is an exemplary implementation of wireless universal serial bus. Wireless USB is a short-range, high-bandwidth wireless extension to USB that combines the speed and ease-of-use of USB 2.0 with the convenience of wireless technology. Wireless USB is sometimes referred to as “Certified Wireless USB” to differentiate it from competitors such as “WirelessUSB” by Cypress Semiconductor.

Wireless USB allows multiple devices to communicate wirelessly, rather than, for example, over a USB cable. In this way the number of cables connected to a computer, printer, or other electronic device can be reduced. For example, wireless USB can be used in devices that are now connected via regular USB cables, such as game controllers, printers, scanners, digital cameras, MP3 players, hard disks and flash drives. Wireless USB is, however, also suitable for transferring parallel video streams.

Wireless USB is based on the WiMedia Alliance's Ultra-WideBand (UWB) common radio platform, which is capable of sending 480 Mbit/s at distances up to 3 meters and 110 Mbit/s at up to 10 meters. It operates in the 3.1 to 10.6 GHz frequency range and spreads communication over an ultra-wideband of frequencies.

Wireless USB, as well as other exemplary wireless connections, such as Bluetooth—IEEE 802.15.1, Wibree, WirelessHD, ZigBee—IEEE 802.15.4, etc. can be less secure than, for example, wired connections. Various methods have been developed to help increase security between wireless links. Some of these methods include the cable model and the numeric model.

Some current wireless connections use a cable model. The cable model can be very secure, but can be cumbersome because it requires that a user initially connect a physical USB cable between the devices. In the cable model, while the devices are connected using various information can be communicated between the devices that can enable wireless communication after the cable is disconnected. For example, a connection key can be communicated between the devices using the USB cable.

Other current wireless connections use the numeric model. The numeric model requires a digital security key exchange over an insecure wireless medium followed by a manual confirmation by a user in order to establish the link. The numeric method is vulnerable to a “man-in-the-middle” attack. In cryptography, a man-in-the-middle attack is an attack in which an attacker is able to read, insert and modify at will, messages between two parties without either party knowing that the link between them has been compromised. Thus, it can be advantageous to develop additional systems and methods that help promote secure wireless connections.

### BRIEF SUMMARY OF EMBODIMENTS OF THE INVENTION

According to various embodiments of the invention a secure alternative to wired or numeric association models currently required by, for example, Wireless USB, can use biometric data to generate a unique security key that can be used to help secure a connection between multiple devices. For example, in one embodiment biometric fingerprint data can be used.

According to another embodiment of the invention a fingerprint reader can be used on a wireless USB host and a wireless USB device to generate a unique key that can be used to establish an initial link between them. The host and device can then generate a connection key that can be used for future communication between the host and the device. Once the connection context has been transferred between the host and the device the fingerprint key can be discarded.

In one embodiment a connection key can be generated in the host and in the device. The key generated by the host and the key generated by the device should be the same because they can be, for example, both be based on the same biometric data (e.g., a fingerprint). If the keys match, then these matching keys can be used for future communication between the host and the device. The biometric key can then be discarded. If the keys do not match, it may be necessary for the user to attempt to reestablish the link, for example, by reading the biometric data again at each device (e.g., by reading the fingerprint over at each device).

In another embodiment a connection key can be generated in either the host or the device. This key can then be transferred between the host and the device using the link established with the biometric key. The biometric key can then be discarded. The connection key can then be used for future communication between the host and the device.

According to another embodiment of the invention, a key generated using biometric data can also be used as a connection key, rather than generating an additional key for use as the connection key. In this embodiment the biometric key (e.g., fingerprint key) would not be discarded.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a block diagram illustrating one possible configuration of a wireless network that can serve as an example environment in which the present invention can be implemented.

FIG. 2 is a flowchart illustrating one example method of generating a connection key.

FIG. 3 is a diagram illustrating one example device in accordance with the systems and methods described herein.

FIG. 4 is a diagram illustrating one example network in accordance with the systems and methods described herein.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Before describing the invention in detail, it is useful to describe an example environment in which the invention can be implemented. One such example is a wireless network in which multiple electronic devices (for example, computers and computing devices, cellular telephones, personal digital assistants, motion and still cameras, among others) can communicate and share data, content and other information with one another. From time-to-time, the present invention is described herein in terms of a network of multiple devices such as a wireless USB connection. Description in terms of this environment is provided to allow the various features and embodiments of the invention to be portrayed in the context of an exemplary application. After reading this description, it will become apparent to one of ordinary skill in the art how the invention can be implemented in different and alternative environments. Indeed, applicability of the invention is not limited to a wireless USB connection. The systems and methods described herein can be applied to other wireless standards, such as Bluetooth, Wibree, WirelessHD, ZigBee, Cypress Semiconductor “WirelessUSB”, and other wireless standards.

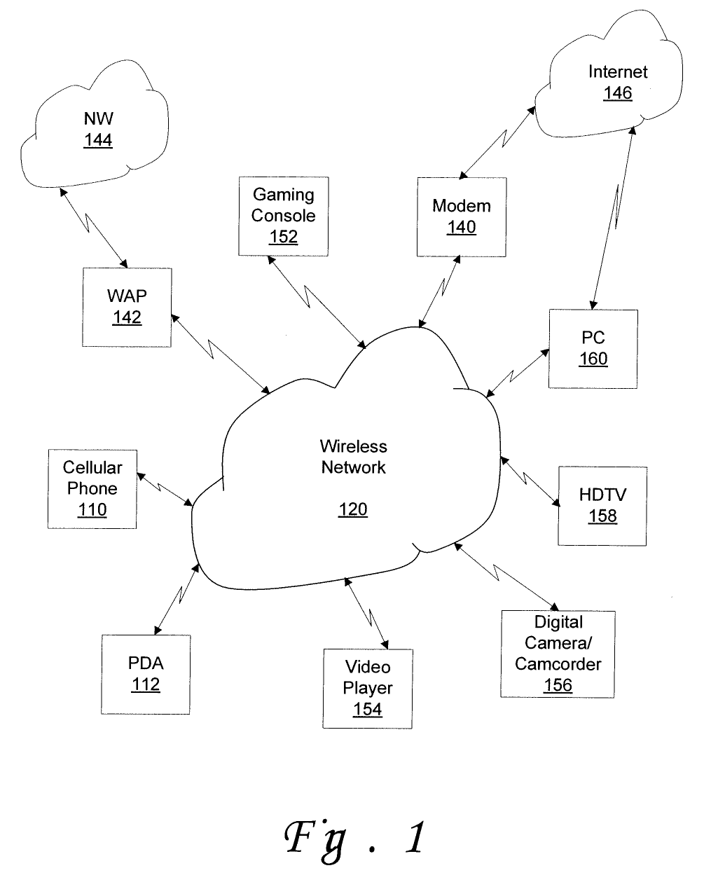

FIG. 1 is a block diagram illustrating one possible configuration of a wireless network that can serve as an example environment in which the present invention can be implemented. Referring now to FIG. 1, a wireless network 120 is provided to allow a plurality of electronic devices to communicate with one another without the need for wires or cables between the devices. A wireless network 120 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations. The wireless network 120 can be, for example, a wireless USB connection, a Bluetooth connection, a Wibree connection, a WirelessHD connection, a ZigBee connection, a Cypress Semiconductor “WirelessUSB” connection, or other wireless connection.

With many applications, the wireless network 120 operates in a relatively confined area, such as, for example, a home or an office. The example illustrated in FIG. 1 is an example of an implementation such as that which may be found in a home or small office environment. Of course wireless communication networks and communication networks in general are found in many environments outside the home and office as well. In the example illustrated in FIG. 1, wireless network 120 includes a communication device to allow it to communicate with external networks. More particularly, in the illustrated example, wireless network 120 includes a modem 140 to provide connectivity to an external network such as the Internet 146, and a wireless access point 142 that can provide external connectivity to another network 144.

Also illustrated in the example wireless network 120 are portable electronic devices such as a cellular telephone 110 and a personal digital assistant (“PDA”) 112. Like the other electronic devices illustrated in FIG. 1, cellular telephone 110 and PDA 112 can communicate with wireless network 120 via the appropriate wireless interface. Additionally, these devices may be configured to further communicate with an external network. For example, cellular telephone 110 is typically configured to communicate with a wide area wireless network by way of a base station.

Additionally, the example environment illustrated in FIG. 1 also includes examples of home entertainment devices connected to wireless network 120. In the illustrated example, electronic devices such as a gaming console 152, a video player 154, a digital camera/camcorder 156, and a high definition television 158 are illustrated as being interconnected via wireless network 120. For example, a digital camera or camcorder 156 can be utilized by a user to capture one or more still picture or motion video images. The captured images can be stored in a local memory or storage device associated with digital camera or camcorder 156 and ultimately communicated to another electronic device via wireless network 120. For example, the user may wish to provide a digital video stream to a high definition television set 158 associated with wireless network 120. As another example, the user may wish to upload one or more images from digital camera 156 to his or her personal computer 160 or to the Internet 146. This can be accomplished by wireless network 120. Of course, wireless network 120 can be utilized to provide data, content, and other information sharing on a peer-to-peer or other basis, as the provided examples serve to illustrate.

Also illustrated is a personal computer 160 or other computing device connected to wireless network 120 via a wireless air interface. As depicted in the illustrated example, personal computer 160 can also provide connectivity to an external network such as the Internet 146.

In the illustrated example, wireless network 120 is implemented so as to provide wireless connectivity to the various electronic devices associated therewith. Wireless network 120 allows these devices to share data, content, and other information with one another across wireless network 120. Typically, in such an environment, the electronic devices would have the appropriate transmitter, receiver, or transceiver to allow communication via the air interface with other devices associated with wireless network 120. These electronic devices may conform to one or more appropriate wireless standards and, in fact, multiple standards may be in play within a given neighborhood. Electronic devices associated with the network typically also have control logic configured to manage communications across the network and to manage the operational functionality of the electronic device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network.

Electronic devices operating as a part of wireless network 120 are sometimes referred to herein as network devices, members or member devices of the network or devices associated with the network. In one embodiment devices that communicate with a given network may be members or merely in communication with the network.

Generally, in a wireless USB connection one device can be referred to as a wireless USB host, or just “host”; while another can be referred to as a wireless USB device, an “external device” or just “device.” A wireless USB device can be, for example, any device that might be connected to a computer or other device, such as a printers, cameras, camcorders, PDA's, cellular phones, video players, HDTV's, modems, keyboards, mice, etc. This list is not intended to be exhaustive. A wireless USB host can be any device that might be connected to a USB device. For example, a computer might be a wireless USB host. It will be understood, however, that devices, such as cellular phones, can be a wireless USB host in some cases. When referring to both a wireless USB host and a wireless USB device the term “devices” may be used. The term “external device” is intended to differentiate a wireless USB device from a wireless USB host. In general an external device will be physically external, i.e., not inside of a wireless USB host, however, the use of this term is not intended to limit wireless USB devices such that they must be external to the wireless USB host.

Several examples of the systems and methods described herein are illustrated using examples that include wireless USB communication. It will be understood that the systems and methods described herein can be used in conjunction with other wireless communication standards. Thus, the terms “host”, “external device”, “device”, “devices”, etc. can refer to devices, systems, or components that implement these other wireless communication standards. Thus, for example, the term “host” might be used to described a computer that uses, for example, the Bluetooth standard to communicate with an external device such as a mobile telephone, PDA, external hard drive, etc.

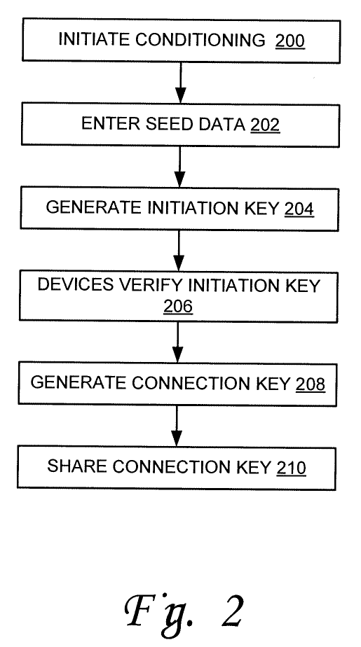

FIG. 2 is a flowchart illustrating one example method of generating a connection key. In a step 200 a user can initiate a condition between a wireless USB host and a wireless USB device. For example, the host and the device can be configured to search for each other.

In a step 202 seed data can be entered. In one embodiment, the seed data can be biometric data. An example using a fingerprint is discussed throughout, however, it will be understood that, many different kinds of biometric data can be used. For example, biometric authentication can use any technologies that measure and analyze human physical and behavioral characteristics for authentication purposes. The data read for authentication purposes can be used as the seed data. Examples of physical characteristics that can be used to generate biometric data include fingerprints, eye retinas and irises, facial patterns and hand measurements. Examples of mostly behavioral characteristics include signatures and typing patterns.

It will be understood that the physical reader and the algorithm used to generate identifying information are preferably be the same or similar between the host and the device such that they generate the same unique key during initial association. In one embodiment the reader can be the same manufacturer and model number and the user can be sure to read the same digit (e.g., left thumb, right index finger, etc.). It will be understood, however, that in some embodiments, as long as the same key will be generated, different readers, or even different algorithms can be used.

The unique key should, in most cases, be large enough to prevent an outside device from computing it by guessing during the association period. In one embodiment, the key can be 1024 bits, for example. In some cases a longer association period for a given implementation may necessitate a longer key because the longer association period can allow an outside device more time to guess. Thus, the length of the key can vary from implementation to implementation.

In a step 204 an initiation key can be generated. This key can be generated using the seed data entered in step 202. Thus, the initiation keys should match if the biometric data matches (e.g., the user reads the same digit at each device) and compatible readers and algorithms are used. If both initiation keys match then the host and the device can communicate using the matching initiation keys.

In one embodiment the initiation key can be used to enable a wireless link between a host and device so that connection context can be exchanged. In another embodiment the initiation key can also be used as a connection key. This can, however, be less secure, because an outside device can have more time to guess the key. Thus, in a step 206 the devices can verify the initiation key and in a step 208 they can generate a connection key that is different from the initiation key. In some embodiments the connection key can be based on the biometric data. In another embodiment the connection key can be based on the connection key. In yet another embodiment the connection key can be generated without using the biometric data so the initiation key.

In another embodiment one connection key can be generated at the host while another connection key can be generated at the device. Both of these connection keys should match. Thus, if biometric data or the initiation keys are used to generate the connection key then the same biometric data or initiation key should be used. If the connection key is generated using some other procedure, the procedure used should be the same or at least compatible in each device. (A compatible procedure is one that will arrive at the same result. Thus, two devices using the same procedure are compatible. Alternatively, two devices that use different procedures that arrive at the same result are also compatible procedures.) If both connection keys match then the host and the device can communicate using the connection keys. Additional connection context can also be exchanged, for example, using the connection key. User data can also be communicated using the connection key.

In another embodiment one device, the host or the wireless USB device can generate a connection key in step 208 and share the key with the other device in a step 210. The host and the device can then communicate using the connection key. Additional connection context can also be exchanged, for example, using the connection key. User data can also be communicated using the connection key.

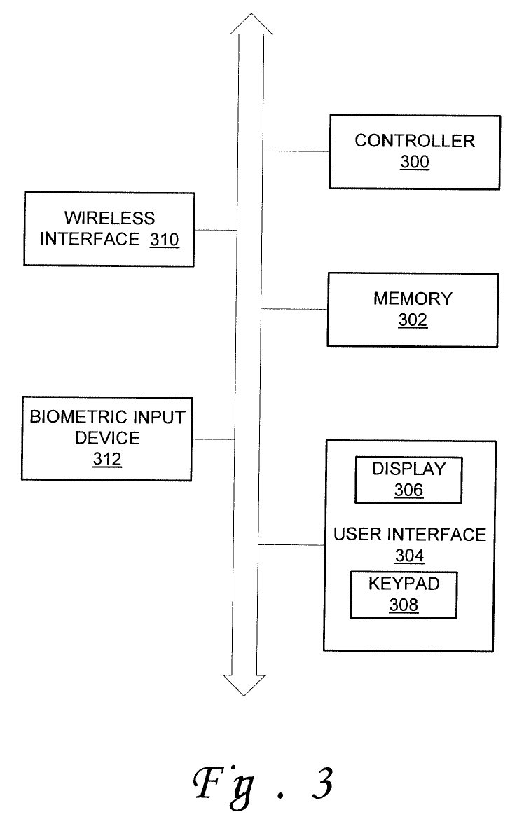

FIG. 3 is a diagram illustrating one example device in accordance with the systems and methods described herein. The device can be a Wireless USB host or a wireless USB device. The example device can include a controller 300. The controller can be a processor, microprocessor, microcontroller, etc. Additionally, controller 300 can be control logic, for example an application specific integrated circuit (“ASIC”), a field programmable gate array (“FPGA”), a complex logic device (“CPLD”), discrete logic, or some combination of these. For example, controller 300 can include a processor and additional control logic.

Controller 300 can be coupled to a memory 302 so that it can read or write the memory 302. Memory 302 can include random access memory (“RAM”), read only memory (“ROM”), flash memory, or other types of memory. Additionally, memory 302 can store data, instructions, or both.

The example device can also include a user interface 304. User interface 304 can include, for example, a display 306 and a keypad 308. The display 306 can be configured to provide a user with output visually. For example, the display 306 can be a computer monitor. Keypad 308 can be a keyboard, numeric keypad, touch screen integrated into the display 306, etc. It will be understood, however, that the example device can use other types of user interfaces. For example, the device can include a mouse, joystick, electronic signature pad, etc.

The example device can include a wireless interface 310. Wireless interface 310 can allow the example device to communicate wirelessly with other devices. For example, the example device can, in one embodiment, communicate with other devices using wireless USB. As discussed above, other wireless communication standards can also be used with the systems and methods described herein.

The example device can also include a biometric input device 312. Biometric input device 312 can be a fingerprint reader. Other biometric readers can also be used. Other example biometric readers include eye scanners for reading retinas, irises, or both; a digital camera and computer combination configured for facial pattern recognition; hand measurements devices, signature pads for inputting signatures or other hand writing samples and keyboards for determining typing patterns.

The example device illustrates one example of a device that can be used with the systems and methods described herein. It will be understood that other devices with other alternative architectures can also be used in conjunction with the systems and methods described herein. Some wireless USB devices or host devices might, for example, lack user interface 304 or other items included in the example of FIG. 3. For example, in one embodiment, a wireless USB device might provide an external hard disk drive. The external hard disk drive might not include user interface 304. Alternatively, the external hard disk drive might include user interface 304, but user interface 304 might not include keypad 308 or display 306. It might simply include, for example, a light emitting diode (“LED”) that indicates when the disk drive is being accessed or an LED that indicates that the drive is being supplied with power or is “on.”

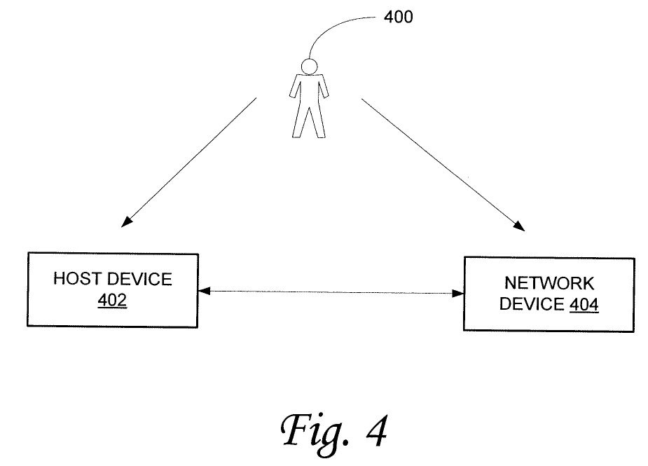

FIG. 4 is a diagram illustrating one example network in accordance with the systems and methods described herein. A user 400 may want to connect a host device 402 to a network device 404 such as a wireless USB device. Host device 402 and network device 404 can each include a wireless interface and a biometric input device. The biometric input device can be a fingerprint reader, eye scanner, digital camera/computer combination, hand measurements device, signature pad, or a keyboard.

User 400 can initiate a connection between host 402 and device 404. Both devices 402 and 404 can be configured to begin looking for each other. Thus, one wireless device 402 or 404 can be configured to try to receive wireless signals from the other device 402 or 404. If both devices 402 and 404 are operating correctly and within range of each other then each device 402 or 404 should receive transmissions from the other device 402 or 404.

So that an unwanted outsider device is not able to communicate with devices 402 or 404 the systems and methods described herein can be used. User 400 can initiate a read by the biometric reader in each device 402 and 404. For example, if the biometric reader in each device is a fingerprint reader then user 400 can initiate a fingerprint read at the host 402 followed by a fingerprint read by the device 404. Generally the order of the reads between the two devices 402 and 404 does not matter. Each of these reads can provide seed data to generate an initiation key. The initiation key can initially be used to allow the devices 402 and 404 to communicate. For example, to communicate connection context between the devices 402 and 404. As discussed above, a connection key can then be generated. The connection key can then be used for subsequent communication between devices 402 and 404.

In one embodiment a connection key can be generated in host 402 and device 404. The key generated by host 402 and the key generated by device 404 should be the same. If the keys match, then these matching keys can be used for future communication between host 402 and device 404. In one embodiment the biometric key can then be discarded. If the keys do not match, it may be necessary for the user to attempt to reestablish the link. For example, by reentering the biometric data (e.g., by re-reading the finger print.) In another embodiment a key can be generated in either host 402 or device 404. This key can then be transferred between host 402 and device 404 using the link established with the biometric key. The biometric key can then be discarded.

Host device 402 can be, for example, a computer such as a laptop computer, desktop computer, a handheld computer, PDA, or any other device capable of being wirelessly connected to network device 404. Network device 404 can be a wireless USB device such as a printer, modem, keyboard, mouse, HDTV, digital camera, camcorder, video player, external hard drive, or any other device capable of being wirelessly connected to host 402. In some embodiments similar devices can be connected using wireless USB, for example, two computers, two PDA's, etc. Further, a computer can be connected to a PDA, handheld computer, etc. In other words, the systems and methods described herein can be applied to almost any device that user 400 would like to connect to any other device, as long as each device has some way to read the seed data. Additionally, the systems and methods described herein can be used in conjunction with other wireless networking or communication standards, for example, Bluetooth, Wibree, WirelessHD, ZigBee, Cypress Semiconductor “WirelessUSB”, etc.

The systems and methods described herein may be implemented using a computer. In one embodiment the computer can be a desktop, laptop, or notebook computer. In another embodiment the computer can be a mainframe, supercomputer or workstation. In yet another embodiment the computer can be a hand-held computing device such as a PDA, smart phone, cell phone, palmtop, etc. The computer may also represent computing capabilities embedded within or otherwise available to a given device.

The computer may include one or more processors, which may be microprocessors, microcontrollers, or other control logic and memory, such as random access memory (“RAM”), read only memory (“ROM”) or other storage device for storing information and instructions for the processor. Other information storage mechanisms may also be connected to the computer, such as a hard disk drive, a floppy disk drive, a magnetic tape drive, an optical disk drive, a CD or DVD drive (R or RW), or other removable or fixed media drive, such as a program cartridge and cartridge interface, a removable memory (for example, a flash memory or other removable memory module) and memory slot, a PCMCIA slot and card, and other fixed or removable storage units and interfaces that allow software and data to be transferred from the storage unit to the computer.

The computer may also include a communications interface that may be used to allow software and data to be transferred between the computer and external devices. Examples of the communications interface may include a modem or softmodem, a network interface (such as an Ethernet, network interface card, or other interface), a communications port (such as for example, a USB port, IR port, RS232 port or other port), or other wired or wireless communications interface. Software and data transferred via the communications interface are carried on signals, which can be electronic, electromagnetic, optical or other signals capable of being received by a given communications interface. The signals may be provided to the communications interface using a wired or wireless medium. Some examples of a channel can include a phone line, a cellular phone link, an RF link, an optical link, a network interface, a local or wide area network, the internet, and other communications channels.

In this document, the terms “computer program medium” and “computer usable medium” are used to generally refer to media such as, for example, the memory, storage unit, media, and signals on a channel. These and other various forms of computer usable media may be involved in carrying one or more sequences of one or more instructions to the processor for execution. Such instructions, generally referred to as “computer program code” (which may be grouped in the form of computer programs or other groupings), when executed, enable the computer to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of associating a plurality of devices, comprising:
entering seed data at a plurality of devices;
generating an initiation key at the plurality of devices based on the seed data to establish a link between the devices; and
generating a connection key for subsequent communications between the devices.

2. The method of claim 1, further comprising sharing the connection key among the plurality of devices.

3. The method of claim 1, further comprising one device searching for another of the plurality of devices.

4. The method of claim 1, further comprising the plurality of devices searching for the other of the plurality of devices.

5. The method of claim 1, wherein entering seed data comprises scanning a biometric attribute at the plurality of devices.

6. The method of claim 4, wherein the biometric attribute comprises a fingerprint.

7. The method of claim 1, wherein one of the plurality of devices is a host device.

8. The method of claim 1, wherein one of the plurality of devices is a wireless USB device.

9. The method of claim 1, wherein the plurality of devices comprise a host and a device to be connected to the host.

10. The method of claim 1, wherein the connection key is generated in a first one of the plurality of devices and transmitted to a second one of the plurality of devices.

11. The method of claim 1, wherein the initial key and the connection key are the same key.

12. The method of claim 1, wherein the connection key is generated using a biometric attribute.

13. The method of claim 1, wherein the seed data is the same in each device.

14. A host device comprising:
a memory, the memory configured to store instructions; and
a controller coupled to the memory and configured to execute the instructions to perform the following steps:
receive seed data entered at the host device;
generate an initiation key at the host device based on the seed data to establish a link between the host and another device; and
generate a connection key for subsequent communications between the host device and the other device.

15. The device of claim 14, further comprising sharing the connection key among the plurality of devices.

16. The device of claim 14, further comprising one device searching for the other device.

17. The device of claim 14, further comprising the plurality of devices searching for the other of the plurality of devices.

18. The device of claim 14, wherein seed data comprises a biometric attribute.

19. The device of claim 18, wherein the biometric attribute comprises a fingerprint.

20. The device of claim 18, wherein the fingerprint is read using a physical reader.

21. The device of claim 14, wherein one of the plurality of devices is a wireless USB device.

22. The device of claim 14, wherein the connection key is generated in the host and the other device.

23. The device of claim 14, wherein the connection key is generated in the host and transmitted to the other device.

24. The device of claim 14, wherein the initial key and the connection key are the same key.

25. The device of claim 14, wherein the connection key is generated using a biometric attribute.

26. The device of claim 14, wherein the seed data is the same in each device.

27. An device to be connected to a host, comprising:
a memory, the memory configured to store instructions;
a controller coupled to the memory and configured to execute the instructions to perform the following steps:
receive seed data entered at the device;
generate an initiation key at the device based on the seed data to establish a link between the host and the device; and
generate a connection key for subsequent communications between the host and the device.

28. The device of claim 27, further comprising sharing the connection key among the plurality of devices.

29. The device of claim 27, further comprising one device searching for the other device.

30. The device of claim 27, further comprising the plurality of devices searching for the other of the plurality of devices.

31. The device of claim 27, wherein seed data comprises a biometric attribute.

32. The device of claim 31, wherein the biometric attribute comprises a fingerprint.

33. The device of claim 32, wherein the fingerprint is read using a physical reader.

34. The device of claim 27, wherein the device is a wireless USB device.

35. The device of claim 27, wherein the connection key is generated in the host and the device.

36. The device of claim 27, wherein the connection key is generated either the host or the device and transmitted to the other of the two.

37. The device of claim 27, wherein the initial key and the connection key are the same key.

38. The device of claim 27, wherein the connection key is generated using a biometric attribute.

39. The device of claim 27, wherein the seed data is the same in each device.
